(19) United States
(12) Patent Application Publication
(10) Pub. No.: US 2025/0232750 A1
(43) Pub. Date: Jul. 17, 2025

(54) EFFECTS UNIT FOR PROCESSING THE ELECTRICAL SIGNALS OF AN INSTRUMENT THROUGH AN INTERNAL EFFECTS DEVICE AND AN EXTERNAL DEVICE IN SOLE, SERIES, AND/OR PARALLEL CONFIGURATIONS

(71) Applicant: Bad Cat Holdings, LLC, Costa Mesa, CA (US)

(72) Inventor: Peter Arends, Costa Mesa, CA (US)

(21) Appl. No.: 18/412,796

(22) Filed: Jan. 15, 2024

(51) Int. Cl. G10H 3/18; G10H 1/045; G10H 1/10; G10H 1/46

(52) U.S. Cl. CPC G10H 3/186; G10H 1/045; G10H 1/10; G10H 1/46; G10H 2250/441

(57) ABSTRACT

Effects units are disclosed which can modify the electrical signals of an instrument like a guitar. These effects units can include an internal effects device, which can modify the instrument's electrical signals by imparting sound effects thereupon, such as those found in conventional effects units, as well as an effects loop where an external device like a preamplifier can be plugged into. An effects unit can have a number of configurations a user can select which produce different signal processing results, such as the electrical signals from the instrument being modified by just the external device, just the internal effects device, first the internal effects device and then the external device, first by the external device and then the internal effects device, and, most uniquely, parallel processing through both the external device and the internal effects device. The resulting output signals can be received and amplified by a power amplifier.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Field of Invention

The present application relates to signal processing of electrical signals from instruments prior to amplification thereof. More specifically, the present application relates to effects units which have multiple configurations to modify the electrical signals from an instrument through an internal effects device of the effects unit and an external device, either alone through one of those devices, through both in series, or both in parallel.

### 2. Related Art

During the 1960s, guitar effects units began to see widespread use to allow a guitar player to further modify their guitar's electrical signals before they were amplified. Effects units in these times typically just refined the sound that would be amplified via variations in the tonal spectrum from clean, crunch, overdrive, distortion, and fuzz. A guitar player's conventional setup would entail their guitar's electric signals being modified first by the effects unit and then by a (pre)amplifier prior to being received and amplified by a (power) amplifier (pre and power amplifier can be housed in the same enclosure and thus constitute the amplifier). With time, new types of effects units were conceived of which imparted other types of effects upon the guitar's electric signals, like reverb and flanger, and the guitarist community discovered that some of these effects could sound more pleasing if they were applied between the preamplifier and power amplifier of a particular amplifier by adding an electric insertion point between the two (after a preamplifier's modifications to the electrical signals as opposed to before it). Since then, many amplifiers have been constructed to include an effects loop, which acts as an insertion point for an effects unit to modify the guitar's signals before the power amplifier but after the preamplifier, to achieve this result.

However, it can prove challenging for a musician to switch between these signal processing methodologies, or switch to a setup that excludes the effects unit or preamplifier, in an efficient manner. Typically, a musician would have to unplug their setup and plug everything back together in the correct order to achieve the sound they desire. If the musician is playing a different song or a particular portion of a song which requires a different sound, this can prove to be a major inconvenience during a concert or while in a recording studio.

Additionally, guitar players are always looking for equipment and technology that can provide new and unique sounds, as they could form the basis of new subgenres and styles of music. Many innovations have been made in amplifiers, such as those disclosed in U.S. Pat. No. 9,620,097 entitled “GUITAR AMPLIFIER CIRCUITY” and U.S. Patent Publication No. 2023/0386438 entitled “AUDIO SIGNAL MANAGEMENT SYSTEM”, the disclosures of which are incorporated herein by reference in their entirety. It can be seen that new and improved methodologies and devices are desired in the art which can allow musicians to switch between different signal processing configurations with ease and/or provide new sounds for their instruments.

### BRIEF SUMMARY

To solve these and other problems, effects units are disclosed which may allow the electrical signals of instruments to be modified via one or several different signal processing configurations. Such an effects unit can include an internal effects device and an effects loop, with the internal effects device being capable of imparting a sound effect upon an instrument's electrical signals, like those found in conventional effects units, and the effects loop being able to receive an external device. This effects unit can further include a multitude of switches within its electric circuitry whose positioning may determine how the electrical signals of an instrument are to be modified. In particular, there may be five different configurations which set these switches to particular positions: an external configuration, an internal configuration, an internal-to-external configuration, an external-to-internal configuration, and, most uniquely, a parallel configuration. The output signal produced by the effects unit and whichever configuration that unit is in may be received and amplified by, to name a number of examples, a power amplifier, a mixing desk, a recording interface, or a further post audio processing device. An effects unit may be capable of switching between these configurations, with a user only needing to actuate the effects unit in one form or another to cause one or more of the circuitry's switches to change position and redirect the instrument's electrical signals accordingly, thus providing a convenient solution to adjust the signal processing methodology of a setup while avoiding the need for a substantial rewiring of a musician's setup.

The external configuration may result in the instrument's electrical signals being modified by the external device independent from the internal effects device. As such, the internal effects device could, in essence, be bypassed or otherwise ignored in this configuration. On the other hand, the internal configuration could have the opposite result, whereby the electrical signals from the instrument are modified by the internal effects device and not by the external device.

The internal-to-external configuration may employ both devices in series, such that the electrical signals from the instrument could first be modified by the internal effects device, whose output could be modified further by the external device. The external-to-internal configuration may flip this order such that the electrical signals from the instrument could be modified by the external device followed by the internal effects device.

A unique sound may be produced in the parallel configuration, whereby the output signals produced by the effects unit are a result of the instrument's electric signals being processed in parallel via two avenues: the electrical signals being modified by the internal effects device independent from the external device and the electrical signals being modified by the external device independent from the internal effects device.

The internal effects device may impart sounds effects upon the instrument's electrical signals similar to those found in conventional effects units, such as distortion, fuzz, boost, overdrive, compression, wah-wah, chorus, flanger, phaser, tremolo, pitch shifting, reverb, or delay. The external device connected to the effects loop may be a preamplifier, an effects unit (either the effects unit disclosed herein, a conventional effects unit, or a future developed effects unit), or comprise one or more of both. Any instrument from which electrical signals can be obtained and amplified may be used, including an electric guitar and an electric bass.

All of these embodiments are contemplated to be within the scope of this disclosure. These and other embodiments will become readily apparent to those skilled in the art form the following detailed description of the preferred embodiments having reference to the attached figures, the disclosure not being limited to any particular preferred embodiment.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a circuit diagram for an exemplary effects unit set to an external configuration and a simplified version thereof;

FIG. 2 is a circuit diagram for the exemplary effects unit of FIG. 1 set to an internal configuration and a simplified version thereof;

FIG. 3 is a circuit diagram for the exemplary effects unit of FIG. 1 set to an internal-to-external configuration and a simplified version thereof;

FIG. 4 is a circuit diagram for the exemplary effects unit of FIG. 1 set to an external-to-internal configuration and a simplified version thereof; and

FIG. 5 is a circuit diagram for the exemplary effects unit of FIG. 1 set to a parallel configuration and a simplified version thereof.

Common reference numerals are used throughout the drawings and the detailed description to indicate the same elements.

### DETAILED DESCRIPTION

Disclosed herein are effects units for modifying the electrical signals from an instrument prior to those signals being amplified through a post signal processing device like a power amplifier. An input of the effects unit can receive electrical signals to be modified, such as signals from a guitar via the guitar being plugged into said input. The effects unit can also have an effects loop where an external device like a preamplifier can be plugged into. The circuitry of the effects unit can include numerous switches, such as three-way switches, which can determine how the input electrical signals are to be modified. Depending on the configuration the effects unit is set to, the received input signals could be modified by just an internal effects device of the effects unit, just the external device, first the internal effects device followed by the external device, or first the external device followed by the internal effects device. Another type of configuration could result in the output signals being the result of parallel processing of the input electrical signals via two avenues: one being the original input signals being modified by just the internal effects device, independent of the external device, and the other being the original input signals being modified by just the external device, independent of the internal effects device. An effects unit could be capable of switching between more than one of these configurations; in such a case, a user could actuate the effects unit to switch between configurations, causing the switches to change position and redirect received input signals through the circuitry to result in different signal processing occurring. A power amplifier can be plugged into the output of the effects unit to receive and amplify the output signals produced. Such an effects unit can provide a user with a multitude of options to modify the sound of their instrument and ease to switch between those options without the need to substantially rewire their equipment, providing convenience when performing or recording music.

An effects unit can take the form of an effects pedal, a rack mounted effects unit, a tabletop unit, prebuilt into an (pre)amplifier, and other forms conventional effects units can take the form of. The effects unit can have an input port for receiving electrical signals to be modified prior to being amplified by a post processing device such as a power amplifier, a mixing desk, a recording interface, or a further post audio processing device. An instrument can be directly plugged into an input port of an effects unit, including, but not being limited to, an electric guitar, an electric bass, an electric organ, an electric piano, synthesizers, drum machines, and other instruments familiar to those skilled in the art; in this respect, an effects unit can be constructed in relation to a particular instrument or the signals to be received by the effects unit. An effects unit can also receive electrical signals from an instrument which have already been modified by another device, such as another effects unit (including the effects units disclosed and described herein, conventional effects units known by those skilled in the art, and future developed effects units). As such, complex setups may be used in which a series of effects units consecutively modify signals from an instrument prior to amplification thereof through a power amplifier. Similarly, the output of an effects unit can be received by a power amplifier and be amplified, or first received by a sequence of one or more other devices such as other effects units before finally being received and amplified by a power amplifier.

An internal effects device of an effects unit can be incorporated into the circuitry of the effects unit such that, depending on the configuration and/or setting of the effects unit, electrical signals received by the input of the effects unit can be modified by the internal effects device. Such modifications the internal effects device can include effects used in conventional effects units, such as distortion, fuzz, boost, overdrive, compressors, wah-wah, chorus, flanger, phaser, tremolo, pitch shifters, reverb, delay, and others familiar to those skilled in the art. It can be seen that an effects unit of this disclosure can replace a conventional effects unit used in a musician's setup, allowing the same effect found in that conventional unit to be imparted upon their instrument's electrical signals while providing the user convenience to switch between different signal processing configurations.

The external device to be plugged into the effects loop of the effects unit may, depending on the configuration and/or setting of the effects unit, additionally or alternatively modify the input signals received by the effects unit. This external device can be a preamplifier, such as the preamplifier that would complement the power amplifier which would amplify the modified signals. In other embodiments, the external device could be another effects unit, such as the effects unit of this present disclosure or other types of conventional or future developed effects units. An external device could also comprise several devices, such as a preamplifier and one or more effects units. In one example, the effects loop of an effects unit of this present disclosure could have a conventional effects unit and a preamplifier having a different conventional effects unit in that preamplifier's effects loop, allowing input signals to be modified through that sequence of devices prior to amplification through the power amplifier. Those skilled in the art would recognize a variety of embodiments in which any number and any type of these effects units, conventional effects units, preamplifiers, and more can be setup to result in different sound modifications being imparted upon an instrument's electrical signals prior to amplification thereof through a power amplifier.

The figures depict the electric circuitry of an exemplary effects unit across five configurations which each result in a different modification of an instrument's electric signals. Those skilled in the art would recognize how this circuitry could be altered to achieve similar results; for instance, three-way switches could be changed to selector switches or toggle switches and/or additional wiring can be added while achieving the same or substantially the same results and interchangeability of these five configurations. Similarly, particular positions of the circuit's switches are shown in the figures, but those skilled in the art would recognize that different combinations of the positions of these switches could yield a similar signal processing result. These figures will also be discussed in relation to a simplistic arrangement in which a guitar is plugged into the effect's unit input, a preamplifier (such as one that is part of an amplifier) is used as the external device plugged into the effects loop of the effects unit, and a power amplifier receives the output signals of the effects unit. However, as discussed above, the device/instrument providing the input signal, the external device, and the device receiving the output from the effects unit can vary amongst a variety of options and/or include multiple devices.

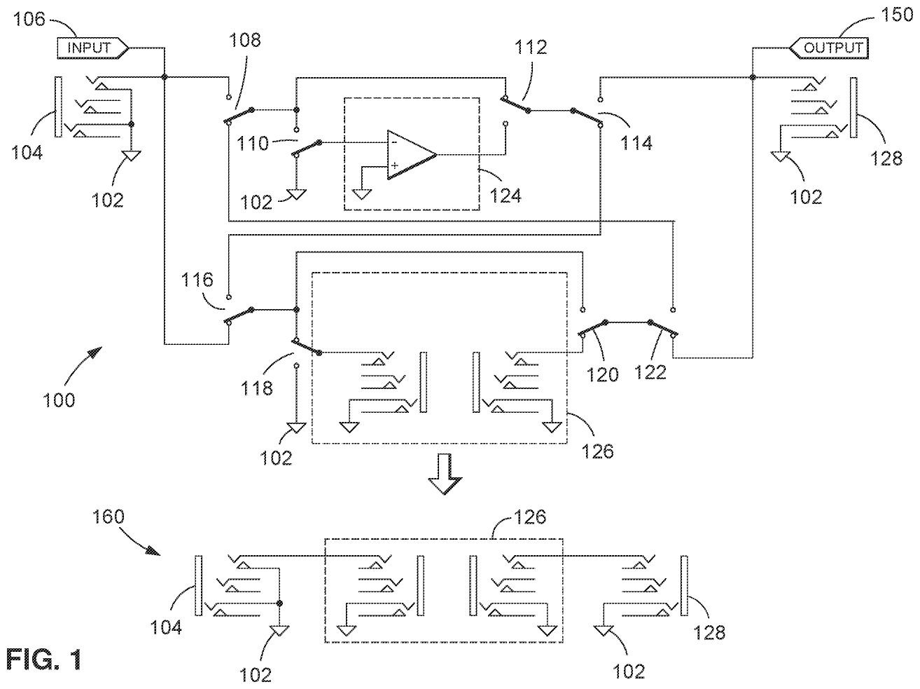

Referring now to FIG. 1, a circuit diagram for an exemplary effects unit set to an external configuration and a simplified version thereof is shown. Each of the figures of this disclosure include signal grounds 102 in appropriate locations of the circuitry. Also, for ease of illustration, a simplified depiction of the internal effects device 124 and the external device 126 are shown, but these devices could have more complex circuitry. The external configuration 100 shown in FIG. 1 may result in input signals 106, received by the effects unit from an instrument 104, being modified by an external device 126 to produce output signals 150, with this signal modification being independent from the internal effects device 124. Switches 108, 110, 112, 114, 116, 118, 120, 122 of the effects unit may be set to certain positions in this external configuration 100 such that the internal effects device 124 is bypassed or otherwise ignored by the input signals 106 (via the positioning of one or more of the switches corresponding to the internal effects device 108, 110, 112, 114), while the external device 126 receives the input signals 106 and modifies them to produce output signals 150 (via the positioning of switches corresponding to the effects loop and external device 116, 118, 120, 122). Output signals 150 produced in this manner can be received and amplified by a power amplifier 128. Such an external configuration 100 may essentially produce the same result as the simplified external circuitry 160, akin to the conventional method of amplifying electrical signals first through a preamplifier followed by a power amplifier.

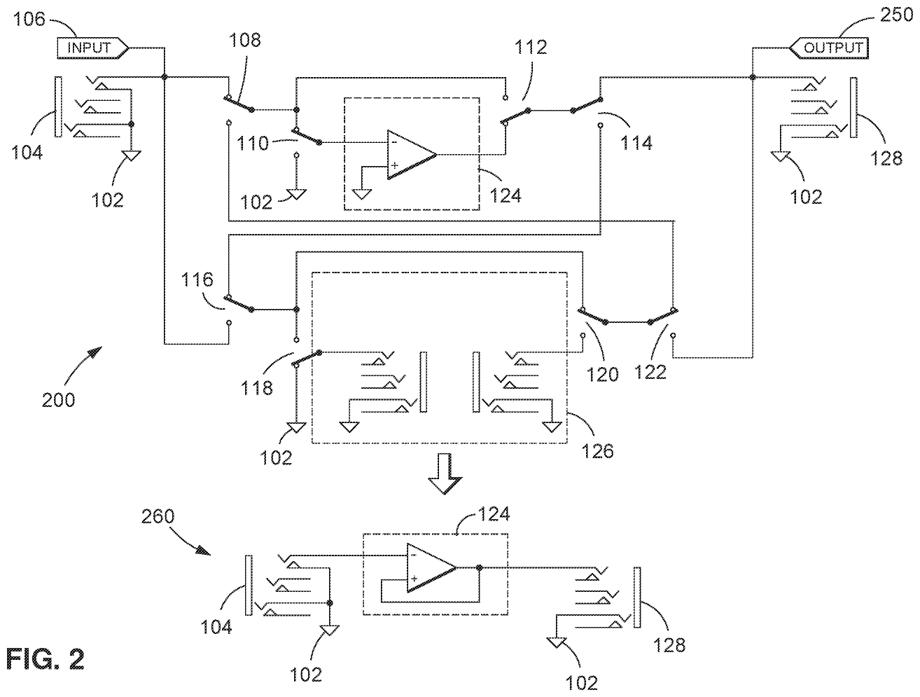

Looking now to FIG. 2, a circuit diagram for the exemplary effects unit of FIG. 1 set to an internal configuration and a simplified version thereof is shown. The internal configuration 200, on the other hand, may send different output signals 250 to the power amplifier 128 by modifying the input signals 106 of the instrument 104 with the internal effects device 124, independent from the external device 126. In this case, the switches corresponding to the internal effects device 108, 110, 112, 114 may be set to provide a pathway for the input signals 106 to be processed in this manner while the switches corresponding to the effects loop 116, 118, 120, 122 may be set so the signals flowing through the circuitry bypass or otherwise ignore the external device 126. The simplified internal circuitry 260 shows the general result this internal configuration 200 can achieve, which may be similar to a setup in which an instrument's electrical signals are modified first by a conventional effects unit and then being sent to the power amplifier without a preamplifier acting upon those signals.

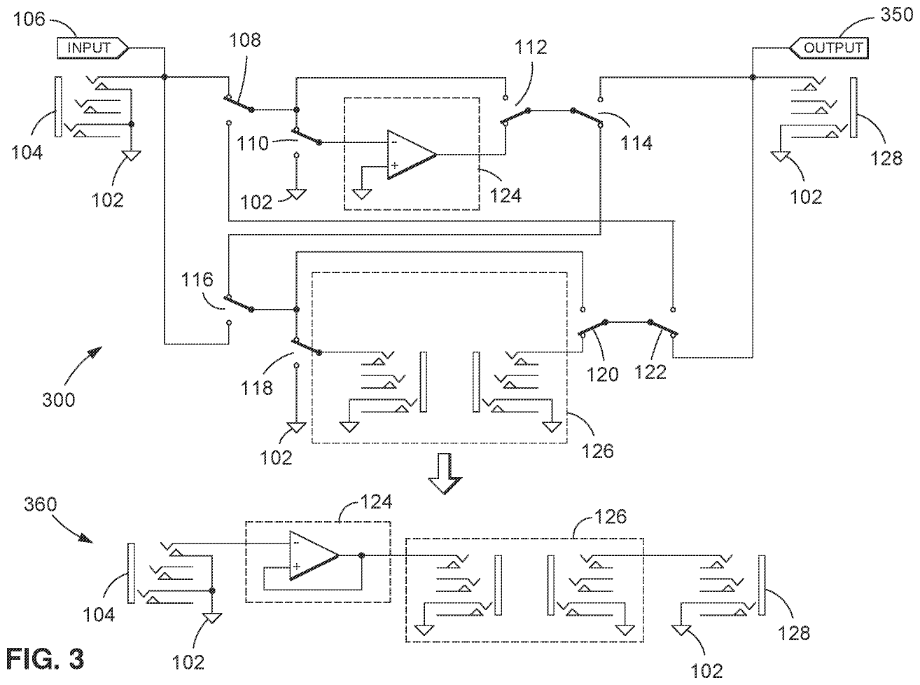

Turning to FIG. 3, a circuit diagram for the exemplary effects unit of FIG. 1 set to an internal-to-external configuration and a simplified version thereof is depicted. The output signals 350 resulting from this internal-to-external configuration 300 may employ both the internal effects device 124 and the external device 126, particularly via the input signals 106 from the instrument 104 being modified first by the internal effects device 126 followed by the external device 126 prior to being received by the power amplifier 128. To achieve this result, the internal-to-external configuration 300 could have particular switches 108, 110, 112 set so as to guide the input signals 106 first through the internal effects device 124 and further have other switches 114, 116, 118, 120, 122 set so as to guide those signals next through the effects loop and external device 126 before finally being sent to the power amplifier 128. The simplified internal-to-external circuitry 360, can mimic the result of feeding the electric signals of a guitar through a conventional effects unit, followed by a preamplifier, and finally at a power amplifier.

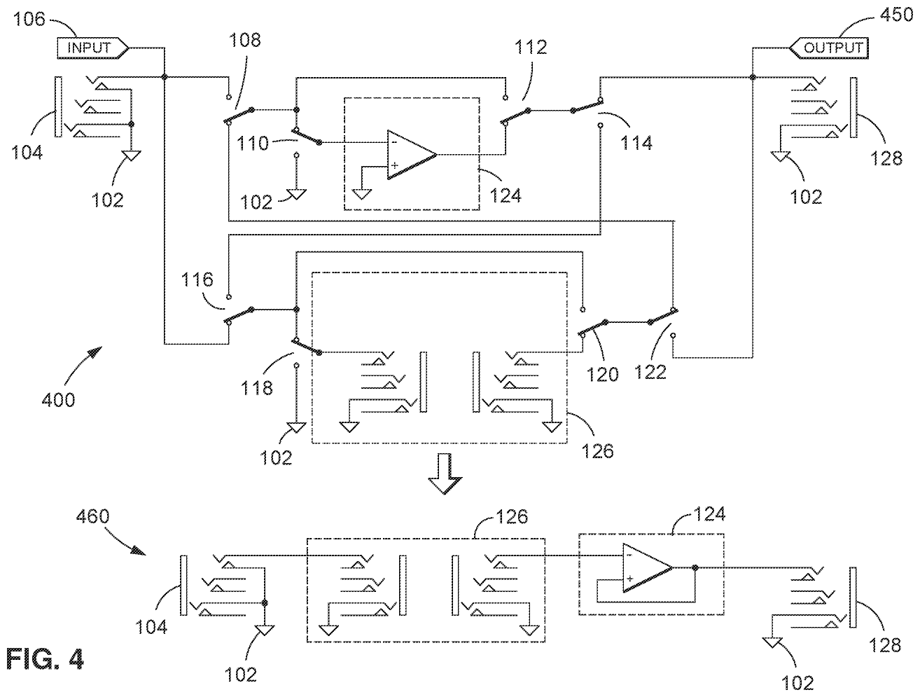

Referring now to FIG. 4, a circuit diagram for the exemplary effects unit of FIG. 1 set to an external-to-internal configuration and a simplified version thereof is shown. Compared to the previous configuration, the external-to-internal configuration 400 may flip the order of the internal effects device 124 and the external device 126 with respect to when they modify electrical signals from an instrument. The output signals 460 produced can be the result of the input signals 106 of the instrument 104 first being received and modified by the external device 126, with the output of the external device 126 next being received and modified by the internal effects device 124. By setting the specific switches 116, 118, 120, the input signals 106 could be received and processed by the external device 126, and with further setting of switches 122, 108, 110, 112, 114, the signals produced by the external device 126 can be modified further by the internal effects device 124 to produce the output signals 450 to be received and amplified by the power amplifier 128. The simplified external-to-internal circuitry 460 shows how this configuration can reflect the processing of the input signals 106 by the external device 126 and the internal effects device 124 in series, which could mirror how a guitar's signals could first be processed by a preamplifier, then by a conventional effects unit, and then sent to a power amplifier.

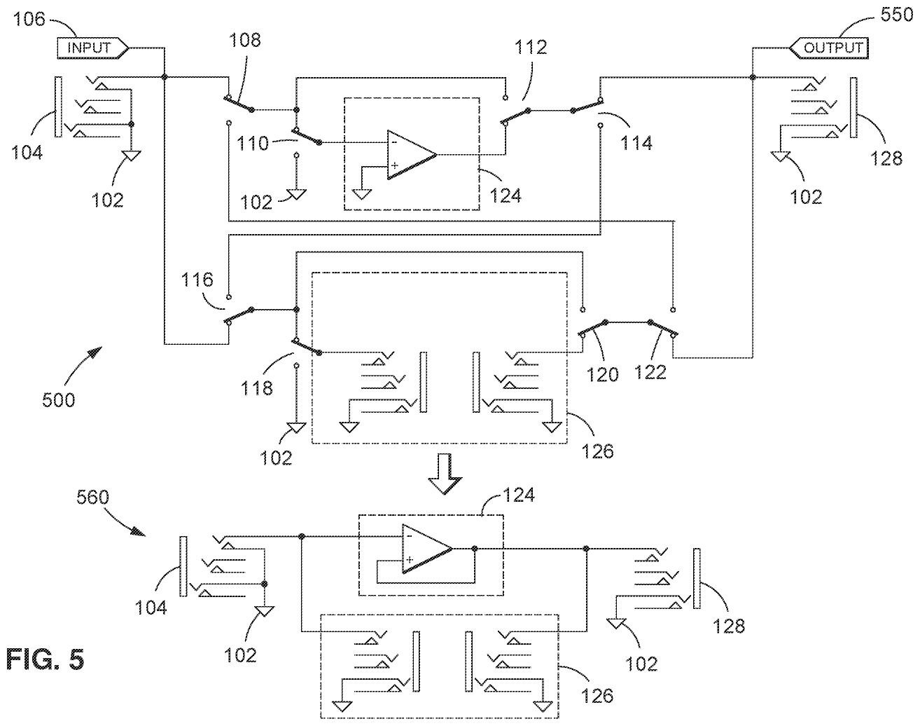

Looking now to FIG. 5, a circuit diagram for the exemplary effects unit of FIG. 1 set to a parallel configuration and a simplified version thereof is illustrated. A unique sound can be produced and amplified from this parallel configuration 500, as these output signals 550 may be the result of the input signals 106 being processed in parallel via two avenues: one being by the internal effects device 124, independent from the external device 125, and the other being by the external device 126, independent from the internal effects device 124. The input signals 106 may be provided two pathways, with one pathway being the result of the positioning of switches 108, 110, 112, 114 and the other arising from the setting of switches 116, 118, 120, 122, to process those input signals 106 in this parallel fashion. The simplified parallel circuitry 560 depicts this parallel circuity processing, which could be likened to a power amplifier receiving two sets of electrical signals from a guitar in parallel: one being those signals modified just by a conventional effects unit, and the other being those signals being modified by just a preamplifier.

An effects unit can be constructed to allow for a user to switch between these configurations with ease. For example, the effects unit could include selectors, dials, levers, and the like, including those used in conventional effects units, which, when actuated by a user, could change the setting of one or more of the switches 108, 110, 112, 114, 116, 118, 120, 122. Labels, coloring, etc. can be implemented on an effects unit to let a user know what setting will result in a particular configuration and corresponding signal processing. Thus, users could be afforded a great convenience in being able to change how the electrical signals from their instruments are processed and amplified by interacting with the effects unit, as opposed to having to rewire their setup. Such a user could therefore easily switch between these configurations in between songs or in the middle of songs. A preferred effects unit will be capable of switching between the five types of signal processing configurations detailed above, but other embodiments may be capable of switching between less than five types or more than five types.

The above description is given by way of example, and not limitation. Given the above disclosure, one skilled in the art could devise variations that are within the scope and spirit of this disclosure. Further, the various features of the embodiments disclosed herein can be used alone, or in varying combinations with each other and are not intended to be limited to the specific combination described herein. Thus, the scope of the claims is not to be limited by the illustrated embodiments. Additional modifications and improvements of the present disclosure may also be apparent to those of ordinary skill in the art. Thus, the particular combination of parts and steps described and illustrated herein is intended to represent only certain embodiments of the present subject matter and is not intended to serve as limitations of alternative devices and methods within the spirit and scope of this disclosure.

What is claimed is:

1. An effects unit for modifying electric signals of an instrument to produce output signals, the effects unit comprising:
an internal effects device;
a plurality of switches for directing the electric signals of the instrument through circuitry of the effects unit; and
an effects loop for an external device;
wherein the effects unit is operative to be set to a parallel configuration, the parallel configuration setting the plurality of switches such that the output signals are produced by processing the electric signals of the instrument in parallel via:
the electric signals of the instrument being modified by the internal effects device independent from the external device, and
the electric signals of the instrument being modified by the external device independent from the internal effects device.

2. The effects unit of claim 1, wherein the effects unit is further operative to be set to an external configuration, the external configuration setting the plurality of switches such that the output signals are produced by the electric signals of the instrument being modified by the external device independent from the internal effects device.

3. The effects unit of claim 1, wherein the effects unit is further operative to be set to an internal configuration, the internal configuration setting the plurality of switches such that the output signals are produced by the electrical signals of the instrument being modified by the internal effects device independent from the external device.

4. The effects unit of claim 1, wherein the effects unit is further operative to be set to an internal-to-external configuration, the internal-to-external configuration setting the plurality of switches such that the output signals are produced by the electric signals of the instrument first being modified by the internal effects device followed by being modified by the external device.

5. The effects unit of claim 1, wherein the effects unit is further operative to be set to an external-to-internal configuration, the external-to-internal configuration setting the plurality of switches such that the output signals are produced by the electric signals of the instrument first being modified by the external device followed by being modified by the internal effects device.

6. The effects unit of claim 1, wherein the external device comprises a preamplifier.

7. The effects unit of claim 1, wherein the external device comprises a conventional effects unit.

8. The effects unit of claim 1, wherein the internal effects device imparts one or more of the following sounds effects upon the electrical signals of the instrument: distortion, fuzz, overdrive, boost, compression, wah-wah, chorus, flanger, phaser, tremolo, pitch shifting, reverb, or delay.

9. The effects unit of claim 1, wherein the output signals are received and amplified by a power amplifier, a mixing desk, a recording interface, or a further post audio processing device.

10. The effects unit of claim 1, wherein the instrument is an electric guitar or an electric bass.

11. An effects unit for modifying electric signals of an instrument to produce output signals, the effects unit comprising:
an internal effects device;
a plurality of switches for directing the electric signals of the instrument through circuitry of the effects unit; and
an effects loop for an external device;
wherein the effects unit is operative to be set to a parallel configuration, the parallel configuration setting the plurality of switches such that the output signals are produced by processing the electric signals of the instrument in parallel via:
the electric signals of the instrument being modified by the internal effects device independent from the external device, and
the electric signals of the instrument being modified by the external device independent from the internal effects device;
wherein the effects unit is further operative to be set to an external configuration, the external configuration setting the plurality of switches such that the output signals are produced by the electric signals of the instrument being modified by the external device independent from the internal effects device;
wherein the effects unit is further operative to be set to an internal configuration, the internal configuration setting the plurality of switches such that the output signals are produced by the electrical signals of the instrument being modified by the internal effects device independent from the external device;
wherein the effects unit is further operative to be set to an internal-to-external configuration, the internal-to-external configuration setting the plurality of switches such that the output signals are produced by the electric signals of the instrument first being modified by the internal effects device followed by being modified by the external device; and
wherein the effects unit is further operative to be set to an external-to-internal configuration, the external-to-internal configuration setting the plurality of switches such that the output signals are produced by the electric signals of the instrument first being modified by the external device followed by being modified by the internal effects device.

12. The effects unit of claim 11, wherein the external device comprises a preamplifier.

13. The effects unit of claim 11, wherein the external device comprises a conventional effects unit.

14. The effect unit of claim 11, wherein the internal effects device imparts one or more of the following sounds effects upon the electrical signals of the instrument: distortion, overdrive, fuzz, boost, compression, wah-wah, chorus, flanger, phaser, tremolo, pitch shifting, reverb, or delay.

15. The effects unit of claim 11, wherein the output signals are received and amplified by a power amplifier, a mixing desk, a recording interface, or a further post audio processing device.

16. The effects unit of claim 11, wherein the instrument is an electric guitar or an electric bass.
